(19) United States
(12) Patent Application Publication
(10) Pub. No.: US 2014/0178600 A1
(43) Pub. Date: Jun. 26, 2014

(54) COATING METHOD AND DEVICE

(71) Applicants: Wenda Chen, Shenzhen (CN); Chujen Wu, Shenzhen (CN)

(72) Inventors: Wenda Chen, Shenzhen (CN); Chujen Wu, Shenzhen (CN)

(73) Assignee: SHENZHEN CHINA STAR OPTOELECTRONICS TECHNOLOGY CO., LTD., Shenzhen, Guangdong (CN)

(21) Appl. No.: 13/813,656

(22) PCT Filed: Dec. 26, 2012
(86) PCT No.: PCT/CN2012/087479

§ 371 Date: Feb. 1, 2013

(30) Foreign Application Priority Data
Dec. 21, 2012 (CN) 201210562933.0

(51) Int. Cl. B05D 3/00; G02F 1/13; B05C 9/14

(52) U.S. Cl. CPC B05D 3/002; B05C 9/14; G02F 1/1303
USPC 427/545; 427/314; 427/554; 427/180; 118/58; 118/641

(57) ABSTRACT

The present disclosure provides a coating method and a coating device. The coating method includes: heating a to-be-coated area of a to-be-coated member; and coating the heated to-be-coated area of the to-be-coated member. Therefore, by pre-heating the to-be-coated area of the to-be-coated member, the temperature of the to-be-coated area of the to-be-coated member is increased to reduce the temperature difference between the to-be-coated area of the to-be-coated member and the coating air flow, which prevents the mixture contained in the coating air flow from generating crystalline material on the to-be-coated area of the to-be-coated member. Thus, the coating layer can be stuck to the to-be-coated area directly and tightly without block from the crystalline material located therebetween, and is prevented from falling off easily to improve the success rate and stability of the coating operation.

### BACKGROUND

1. Technical Field

The present disclosure relates to manufacturing technologies of liquid crystal panels, and particularly, to a coating method and a coating device.

2. Description of Related Art

A liquid crystal panel includes an array substrate, a color filter substrate, and a liquid crystal layer arranged between the array substrate and the color filter substrate. The array substrate is one of the important components of the liquid crystal panel. A number of signal lines such as data lines and scanning lines are formed on the array substrate. Due to different reasons, the signal line on the array substrate may have a disconnected defect, that is, the signal line may be disconnected. In order to improve the yield rate of the array substrate, a coating device is used for coating a metal coating layer on the area corresponding to the disconnected defect to repair the disconnected signal line.

When coating the metal coating layer, since the coating device supplies coating air flow containing high temperature molten mixture to the array substrate, and the array substrate is exposed to normal temperature, thus, the temperature difference between the array substrate and the coating air flow is great, which causes the mixture in the coating air flow to generate crystalline material after contacting the array substrate. The crystalline material may block the coating layer and the array substrate after the crystalline material falling on a to-be-coated area, which prevents the coating layer from being stuck to the array substrate tightly and further looses the coating layer. In this way, the coating layer may be separated from the array substrate easily to cause the failure of the coating operation and reduces the yield rate of the array substrate.

### SUMMARY

The present disclosure provides a coating method and a coating device for improving the success rate and stability of the coating operation.

The coating method provided in the present disclosure includes: heating a to-be-coated area of a to-be-coated member; and coating the heated to-be-coated area of the to-be-coated member.

Preferably, the step of heating a to-be-coated area of a to-be-coated member includes: heating the to-be-coated area of the to-be-coated member by using a laser heating device or a resistance heating device.

Preferably, the step of heating a to-be-coated area of a to-be-coated member includes: emitting laser light beams and converging the laser light beams to the to-be-coated area to heat the to-be-coated area.

Preferably, the step of heating a to-be-coated area of a to-be-coated member includes: heating air and blowing the heated air to the to-be-coated area of the to-be-coated member to heat the to-be-coated area.

Preferably, the step of heating air and blowing the heated air to the to-be-coated area of the to-be-coated member to heat the to-be-coated member includes: blowing air into a heat conducting pipe by using an air blasting member; heating the air blown into the heat conducting pipe by a resistance heating member arranged in the heating conducting pipe; and transmitting the heated air to the to-be-coated area to heat the to-be-coated area.

Preferably, the step of coating the heated to-be-coated area of the to-be-coated member includes: transmitting coating air flow containing mixture of metal powder to the heated to-be-coated area of the to-be-coated member; and decomposing the mixture of metal powder to produce metal particles such that the metal particles can be stuck to the to-be-coated area to form a coating layer.

The coating device provided in the present disclosure includes: a heating unit for heating a to-be-coated area of a to-be-coated member; and a coating unit for coating the heated to-be-coated area of the to-be-coated member.

Preferably, the heating unit is a laser heating unit or a resistance heating unit.

Preferably, the heating unit is a laser heating unit including a laser emitter and a light converging member, and laser light beams emitted from the laser emitter irradiate the to-be-coated area of the to-be-coated member after being converged by the light converging member.

Preferably, the coating unit includes a blocking glass piece, the laser heating unit and the coating unit are located at a same side of the to-be-coated member, and the block glass piece is used as the light converging member of the laser heating unit by using converging glass.

Preferably, the heating unit is a resistance heating unit including a heat conducting pipe, a heating resistance and an air blasting member arranged in the heating conducting pipe; the air blasting pipe blows air into the heat conducting pipe, and the air is transmitted to the to-be-coated area of the to-be-coated member after being heated by the heating resistance.

Preferably, the heat conducting pipe is annular shaped, and the coating unit is surrounded by the heat conducting pipe.

Preferably, the heating unit and the coating unit are arranged side by side, and the heating unit and the coating unit are located at a same side of the to-be-coated member or are respectively located at two sides of the to-be-coated member.

Preferably, the coating unit includes a coating chamber, a blocking glass piece fixed on the coating chamber and a laser device, the coating chamber transmits coating air flow to the heated to-be-coated area, the blocking glass piece blocks the coating air flow from floating, and the laser device emit laser light beams to the coating air flow of the to-be-coated area through the blocking glass piece.

In the coating method provided in the present disclosure, by pre-heating the to-be-coated area of the array substrate, the temperature of the to-be-coated area of the array substrate is increased to reduce the temperature difference between the to-be-coated area of the array substrate and the coating air flow, which prevents the mixture contained in the coating air flow from generating crystalline material on the to-be-coated area of the array substrate. Thus, the coating layer can be stuck to the array substrate directly and tightly without block from the crystalline material located therebetween, and is prevented from falling off easily to improve the success rate and stability of the coating operation.

### DESCRIPTION OF THE DRAWINGS

Many aspects of the embodiments can be better understood with reference to the following drawings. The components in the drawings are not necessarily dawns to scale, the emphasis instead being placed upon clearly illustrating the principles of the embodiments. Moreover, in the drawings, like reference numerals designate corresponding parts throughout the several views.

FIG. 1 is a flow chart of a coating method in accordance with a first embodiment of the present disclosure;

FIG. 2 is a flow chart of a coating method in accordance with a second embodiment of the present disclosure;

FIG. 3 is a schematic view of a coating device of the present disclosure;

FIG. 4 is a schematic view of a coating device in accordance with a first embodiment of the present disclosure; and

FIG. 5 is a schematic view of a coating device in accordance with a second embodiment of the present disclosure

### DETAILED DESCRIPTION

The disclosure is illustrated by way of example and not by way of limitation in the figures of the accompanying drawings in which like references indicate similar elements. It should be noted that references to “an” or “one” embodiment is this disclosure are not necessarily to the same embodiment, and such references mean at least one.

Referring to FIG. 1, which is a flow chart of a coating method in accordance with a first embodiment of the present disclosure. The coating method includes the following steps.

Step S101, heating a to-be-coated area of a to-be-coated member.

Before being coated, the to-be-coated area of the to-be-coated member is heated to increase the temperature of the to-be-coated area of the to-be-coated member, thereby reducing the temperature difference between the to-be-coated area of the to-be-coated member and the coating air flow.

A heating device such as a laser heating device or a resistance heating device can be used to heat the to-be-coated area of the to-be-coated area. The heating device can be integrally formed with a coating device or be independently formed from the coating device. The heating device and the coating device can be arranged side by side to heat the to-be-coated member and coat the to-be-coated member at the same side of the to-be-coated member. The heating device and the coating device can be opposite to each other to be respectively located at two sides of the to-be-coated member.

When heating the to-be-coated member by the laser heating device, laser light beams emitted from a laser emitter of the laser heating device irradiate the to-be-coated area of the to-be-coated member after being converged. The converged laser light beams thus heat the to-be-coated area to improve the temperature thereof. When heating the to-be-coated member by the resistance heating device, an outlet of a heat conducting pipe of the resistance heating device corresponds to the to-be-coated area of the to-be-coated member. An air blasting member of the resistance heating device such as a fan blows air into the heat conducting pipe to allow a heated resistance in the heat conducting pipe to heat the incoming air. After that, the heated air blows to the to-be-coated area to heat the to-be-coated area, thereby improving the temperature thereof.

Step S102, coating the heated to-be-coated area of the to-be-coated member. After the to-be-coated area of the to-be-coated member is heated, the temperature of the to-be-coated area is increased. Thus, when the to-be-coated area is coated, the temperature difference between high temperature molten coating air flow ejected from the coating device and the to-be-coated area is small or even can be ignored. Thus, mixture in the coating air flow cannot form crystalline material on the to-be-coated area, and the adhesive force of a coating layer on the to-be-coated area formed by the coating air flow is not affected, which allows the coating layer to be stuck to the to-be-coated area directly to be in close connection with the to-be-coated member, and further improves the success rate and stability of the coating operation.

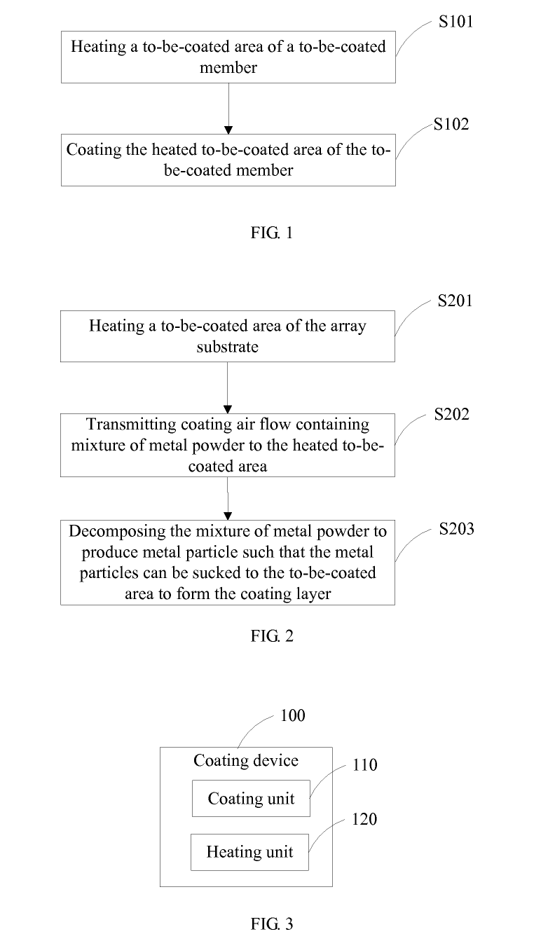

Referring to FIG. 2, which is a flow chart of a coating method in accordance with a first embodiment of the present disclosure. The coating method can be applied in technologies of liquid crystal panels. When a signal line of an array substrate of the liquid crystal panel has a disconnected defect, the disconnected area of the disconnected line needs to be coated to repair the signal line. The following embodiment is described based on coating a metal coating layer on the array substrate. The coating method includes the following steps.

Step S201, heating a to-be-coated area of the array substrate. The to-be-coated member of the embodiment is the array substrate with a signal line needed to be repaired. Only the to-be-coated area of the array substrate is heated to prevent other components on the array substrate from being affected by high temperature and to reduce unnecessary consumption and waste of energy. At this time, the to-be-coated area corresponds to the area of the array substrate where the metal coating layer is required to be coated for the disconnected signal line on the array substrate.

When heating the array substrate by the laser heating device, laser light beams emitted from a laser emitter of the laser heating device irradiate the to-be-coated area of the array substrate after being converged. The converged laser light beams thus heat the to-be-coated area to improve the temperature thereof. When heating the array substrate by the resistance heating device, an outlet of a heat conducting pipe of the resistance heating device corresponds to the to-be-coated area of the array substrate. An air blasting member of the resistance heating device such as a fan blows air into the heat conducting pipe to allow a heated resistance in the heat conducting pipe to heat the incoming air. After that, the heated air blows to the to-be-coated area to heat the to-be-coated area, thereby improving the temperature thereof.

Step S202, transmitting coating air flow containing mixture of metal powder to the heated to-be-coated area.

A coating device ejects the high temperature molten coating air flow to the to-be-coated area of the array substrate. Since the to-be-coated area is pre-heated, thus, the temperature difference between the coating air flow and the to-be-coated area is small or even can be ignored. In this way, the metal powder contained in the coating air flow does not generate crystalline material on the to-be-coated area.

Step S203, decomposing the mixture of metal powder to produce metal particle such that the metal particles can be sucked to the to-be-coated area to form the coating layer.

The coating device emits laser light beams to decompose the mixture of metal powder. Since the metal particles decomposed from the mixture of metal powder are at high temperature molten state, thus, the metal particles can be stuck to the to-be-coated area of the array substrate to form the metal coating layer, thereby repairing the signal line having the disconnected defect. Since the to-be-coated area of the array substrate is heated, the temperature difference between the to-be-coated area and the metal particles are small or even can be ignored, thus, the metal particles stuck to the to-be-coated area of the array substrate do not generate crystalline material. In this way, the metal coating layer does not fall off easily because the adhesive force of the metal coating layer on the to-be-coated area of the array substrate is strengthened.

By pre-heating the to-be-coated area of the array substrate, the temperature of the to-be-coated area of the array substrate is increased to reduce the temperature difference between the to-be-coated area of the array substrate and the coating air flow, which prevents the mixture contained in the coating air flow from generating crystalline material on the to-be-coated area of the array substrate. Thus, the coating layer can be stuck to the array substrate directly and tightly without block from the crystalline material located therebetween, and is prevented from falling off easily to improve the success rate and stability of the coating operation.

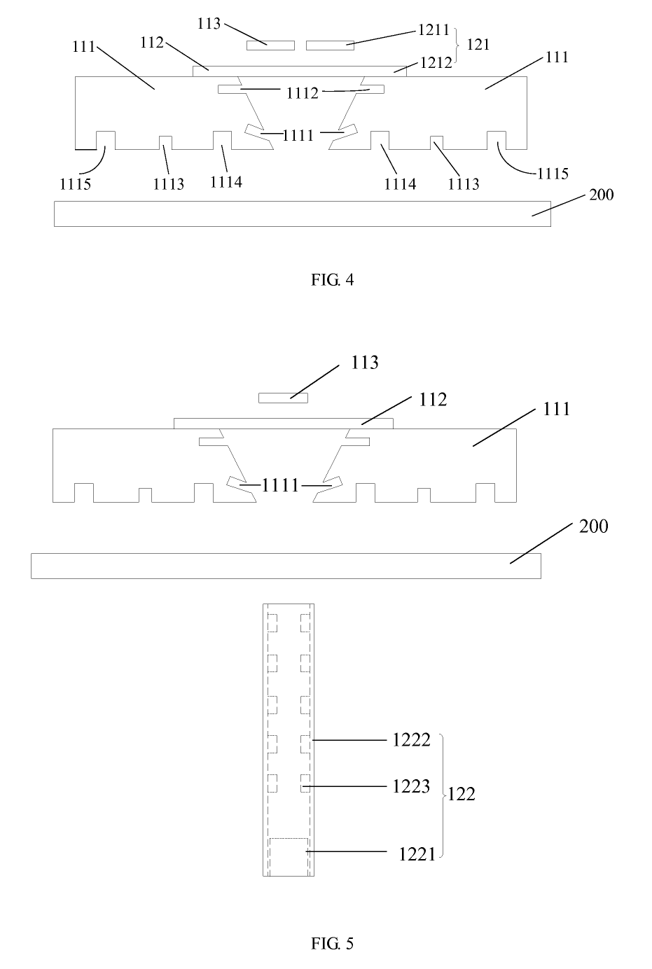

Referring to FIGS. 3 to 5, the present disclosure further provides a coating device 100. The coating device 100 includes a heating unit 120 and a coating unit 110. The heating unit 120 is used for heating a to-be-coated area of a to-be-coated member, and the coating unit 110 is used for coating the heated to-be-coated area of the to-be-coated member. The heating unit 120 can be a laser heating unit 121 or a resistance heating unit 122, etc.

Referring also to FIG. 4, the coating device in accordance with a first embodiment is provided. The coating device 100 includes the laser heating unit 121 and the coating unit 110. The laser heating unit 121 includes a laser emitter 1211 and a light converging member 1212. Laser light beams emitted from the laser emitter 1211 irradiate the to-be-coated area of the to-be-coated member after being converged by the light converging member 1212. The coating unit 110 includes a coating chamber 111, a blocking glass piece 112, and a laser device 113. The coating chamber 111 forms a coating channel. The blocking glass piece 112 is arranged on above the coating channel. The coating chamber 111 includes first outlets 1111, second outlets 1112, third outlets 1113, and discharging openings 1114. Powdered coating material used for forming a coating layer is blown out from each first outlet 1111 which is arranged above the to-be-coated area. The second outlets 1112 are arranged above the first outlets 1111 for blowing out gas such as inert gas which cannot react with the coating material. The inert gas blown out form the second outlets 1112 is mixed with the coating material blown out from the first outlets 1111. The third outlets 1113 corresponds to one sides of the first outlets 1111 for blowing out inert gas to prevent the mixture of the inert gas blown out from the second outlets 1112 and the coating material from spreading to other areas of the to-be-coated member. The discharging openings 1114 are arranged between the first outlets 1111 and the third outlets 1113 for discharging the mixture of the coating material and the inert gas. The laser device 113 emits laser light beams to the to-be-coated area of the to-be-coated member 200 through the blocking glass piece 112. The laser light beams decompose the powdered coating material to produce metal particles such that the metal particles can be stuck to the to-be-coated member 200 to form a coating layer. The blocking glass piece 112 prevents the mixture air flow of the powdered coating material and inert gas from floating. Preferably, the coating chamber 111 further includes second discharging openings 1115. Second discharging openings 1115 and the discharging openings 1114 are respectively located at two sides of the third outlets 1113 for discharging the gas blown out from the third outlets 1113.

The laser heating unit 121 and the coating unit 110 can be arranged side by side for heating and coating the to-be-coated member 200 at the same side of the to-be-coated member 200. Thus, the laser emitter 1211 of the laser heating unit 121 and the laser device 113 of the coating unit 110 can be arranged side by side to emit the laser light beams to the to-be-coated member 200 through the blocking glass piece 112. At this time, the blocking glass piece 112 can be a piece of converging glass which can be used as the light converging member 1212 of the laser heating unit 121.

It is noted that the laser heating unit 121 and the coating unit 110 can be opposite to each other. The laser heating unit 121 and the coating unit 110 can be respectively located at two sides of the to-be-coated member 200, thus, the laser heating unit 121 can heat the to-be-coated member at one side of the to-be-coated member and the coating unit 110 can coat the to-be-coated area at the other side of the to-be-coated member.

The coating process of the coating device 100 is described hereafter based on the example in which the coating device 100 is used for coating a metal coating layer on the area corresponding to the disconnected signal line to repair the disconnected signal line on the array substrate.

The light beams emitted from the laser emitter 1211 of the laser heating unit 121 irradiate the to-be-coated area (that is, the area of the array substrate corresponding to the disconnected signal line) of the to-be-coated member 200 after being converged by the light converging member 1212, which pre-heats the to-be-coated area to increase the temperature thereof The powdered coating material blown out from the first outlets 1111 of the coating unit 110 is mixed with the inert gas to form the coating air flow. Since the temperature difference between the to-be-coated area and the coating air flow is small, thus, the mixture of metal powder contained in the coating air flow does not generate crystalline material on the to-be-coated area. At the same time, the laser device 113 emits laser light beams to the to-be-coated area to decompose the coating air flow to produce the metal particles, allowing the metal particles to be stuck to the to-be-coated member 200 to form the metal coating layer. Since there is no block from the crystalline material between the metal coating layer and the to-be-coated member 200, the metal coating layer can be stuck to the to-be-coated member 200 to be in tight connection with the to-be-coated member 200.

With the laser heating unit 121 pre-heating the to-be-coated area of the to-be-coated member 200, the temperature of the to-be-coated member 200 can be increased to reduce the temperature difference between the to-be-coated area and the coating air flow. This prevents the mixture in the coating air flow from generating crystalline material on the to-be-coated area of the to-be-coated member 200, guaranteeing no block from the crystalline material between the metal coating layer and the to-be-coated member 200. In this way, the metal coating layer can be tightly stuck to the to-be-coated area to improve the success rate and stability of the coating operation.

Referring to FIG. 5, a coating device in accordance with a second embodiment is provided. The difference between the coating device of the second embodiment and that of the first embodiment lies that, the heating unit of the coating device of the second embodiment is a resistance heating unit 122. The resistance heating unit 122 includes an air blasting member 1221, a heat conducting pipe 1222, and a heating resistance 1223 arranged in the heat conducting pipe 1222. The air blasting member 1221 can be arranged in the heat conducting pipe 1222, or can be arranged outside the heat conducting pipe 1222 corresponding to an inlet of the heat conducting pipe 1222. A power source (not shown) supplies electrical current to the heating resistance 1223 to heat the heating resistance 1223. The air blasting member 1221 blows air into the heat conducting pipe 1222. The air is heated by the heating resistance 1223 and is transmitted to the to-be-coated area of the to-be-coated member 200 through the heat conducting pipe 1222.

As shown in FIG. 5, the resistance heating unit 122 and the coating unit 110 can be opposite to each other and be respectively located at two sides of the to-be-coated member 200. An outlet of the heat conducting pipe 1222 corresponds to the to-be-coated area, which allows the resistance heating unit 122 to heat the to-be-coated area at one side of the to-be-coated member and coating unit 110 to coat the heated to-be-coated area at the other side of the to-be-coated member.

The resistance heating unit 122 and the coating unit 110 can be arranged side by side and located at the same side of the to-be-coated member 200. The resistance heating unit 122 can surround the coating unit 110, that is, the resistance heating unit 122 can be an annular pipe. The coating unit 110 is surrounded by the annular-shaped heat conducting pipe 1222, allowing the resistance heating unit 122 and the coating unit 110 to correspond to the same position of the to-be-coated member 200. Thus, the resistance heating unit 122 and the coating unit 110 can respectively heat the to-be-coated member 200 and coat the to-be-coated member 200 at the same side.

The coating process of the coating device of the embodiment can be described as the follows. The outlet of the heat conducting pipe 1222 of the resistance heating unit 122 corresponds to the to-be-coated area of the to-be-coated member 200. The air blasting member 1221 such as a fan blows air into the heat conducting pipe 1222. The heating resistance 1223 arranged inside the heat conducting pipe 1222 heats the air, and the heated air blows to the to-be-heated area, thereby heating the to-be-heated area to improve the temperature thereof. Powdered coating material is blown out from the first outlet 1111 to mix with the inert gas to form the coating air flow. Since the temperature difference between the heated to-be-coated area and the coating air flow is small, therefore, the mixture of metal powder in the coating air flow does not generate crystalline material on the to-be-coated area. Meanwhile, the laser device 113 emits laser light beams to the to-be-coated area to decompose the coating air flow to produce the metal particles such that the metal particles can be stuck to the to-be-coated member to form the metal coating layer. Since there is no block from the crystalline material between the metal coating layer and the to-be-coated member 200, the metal coating layer can be stuck to the to-be-coated member 200 directly to improve the success rate and stability of the coating operation.

Even though information and the advantages of the present embodiments have been set forth in the foregoing description, together with details of the mechanisms and functions of the present embodiments, the disclosure is illustrative only; and that changes may be made in detail, especially in matters of shape, size, and arrangement of parts within the principles of the present embodiments to the full extend indicated by the broad general meaning of the terms in which the appended claims are expressed.

What is claimed is:

1. A coating method, comprising:
heating a to-be-coated area of a to-be-coated member; and
coating the heated to-be-coated area of the to-be-coated member.

2. The coating method of claim 1, wherein the step of heating a to-be-coated area of a to-be-coated member comprises:
heating the to-be-coated area of the to-be-coated member by using a laser heating device or a resistance heating device.

3. The coating method of claim 1, wherein the step of heating a to-be-coated area of a to-be-coated member comprises:
emitting laser light beams and converging the laser light beams to the to-be-coated area to heat the to-be-coated area.

4. The coating method of claim 1, wherein the step of heating a to-be-coated area of a to-be-coated member comprises:
heating air and blowing the heated air to the to-be-coated area of the to-be-coated member to heat the to-be-coated area.

5. The coating method of claim 4, wherein the step of heating air and blowing the heated air to the to-be-coated area of the to-be-coated member to heat the to-be-coated member comprises:
blowing air into a heat conducting pipe by using an air blasting member; heating the air blown into the heat conducting pipe by a resistance heating member arranged in the heating conducting pipe; and transmitting the heated air to the to-be-coated area to heat the to-be-coated area.

6. The coating method of claim 1, wherein the step of coating the heated to-be-coated area of the to-be-coated member comprises:
transmitting coating air flow containing mixture of metal powder to the heated to-be-coated area of the to-be-coated member; and
decomposing the mixture of metal powder to produce metal particles such that the metal particles can be stuck to the to-be-coated area to form a coating layer.

7. A coating device, comprising:
a heating unit for heating a to-be-coated area of a to-be-coated member; and
a coating unit for coating the heated to-be-coated area of the to-be-coated member.

8. The coating device of claim 7, wherein the heating unit is a laser heating unit or a resistance heating unit.

9. The coating device of claim 7, wherein the heating unit is a laser heating unit comprising a laser emitter and a light converging member, and laser light beams emitted from the laser emitter irradiate the to-be-coated area of the to-be-coated member after being converged by the light converging member.

10. The coating device of claim 9, wherein the coating unit comprises a blocking glass piece, the laser heating unit and the coating unit are located at a same side of the to-be-coated member, and the block glass piece is used as the light converging member of the laser heating unit by using converging glass.

11. The coating device of claim 7, wherein the heating unit is a resistance heating unit comprising a heat conducting pipe, a heating resistance and an air blasting member arranged in the heating conducting pipe; the air blasting pipe blows air into the heat conducting pipe, and the air is transmitted to the to-be-coated area of the to-be-coated member after being heated by the heating resistance.

12. The coating device of claim 11, the heat conducting pipe is annular shaped, and the coating unit is surrounded by the heat conducting pipe.

13. The coating device of claim 7, wherein the heating unit and the coating unit are arranged side by side, and the heating unit and the coating unit are located at a same side of the to-be-coated member or are respectively located at two sides of the to-be-coated member.

14. The coating device of claim 7, wherein the coating unit comprises a coating chamber, a blocking glass piece fixed on the coating chamber and a laser device, the coating chamber transmits coating air flow to the heated to-be-coated area, the blocking glass piece blocks the coating air flow from floating, and the laser device emit laser light beams to the coating air flow of the to-be-coated area through the blocking glass piece.
